(19) United States
(12) Patent Application Publication
(10) Pub. No.: US 2014/0358727 A1
(43) Pub. Date: Dec. 4, 2014

(54) PROVIDING ENHANCED CUSTOMER EXPERIENCES

(71) Applicant: Bank of America Corporation, Charlotte, NC (US)

(72) Inventors: Stephen Thomas Shannon, Charlotte, NC (US); Todd Jon Price, Waxhaw, NC (US)

(21) Appl. No.: 13/906,849

(22) Filed: May 31, 2013

(51) Int. Cl. G06Q 30/06

(52) U.S. Cl. CPC G06Q 30/0613
USPC 705/26.41

(57) ABSTRACT

Methods, systems, computer-readable media, and apparatuses for providing enhanced customer experiences are presented. In some embodiments, a computing device may receive information about a mobile device detected within a predetermined distance of a retail location. Subsequently, the computing device may determine, based on the received information, an identity of a customer using the mobile device. The computing device also may determine one or more needs of the customer based on the identity of the customer. Thereafter, the computing device may generate routing information for the customer based on the identity of the customer and the one or more determined needs of the customer. In some instances, determining the one or more needs of the customer may include predicting at least one need of the customer based on at least one of customer product information, customer presence information, customer history information, customer account information, and customer profile information.

### BACKGROUND

Aspects of the disclosure relate to computer hardware and software. In particular, one or more aspects of the disclosure generally relate to computer hardware and software for providing enhanced customer experiences.

Mobile devices, such as smart phones, tablet computers, laptop computers, and other types of mobile computing devices, are becoming increasingly popular. Additionally, people are using mobile devices in a growing number of diverse ways. For example, in addition to using mobile devices to communicate with other people (e.g., via telephone calls, text messaging, electronic mail, and the like), many people are also using mobile devices for entertainment purposes, organizational purposes, and other purposes. Some people are even using their mobile devices for online banking and financial account management purposes (e.g., by utilizing various websites and/or software applications, also known as “apps,” that allow users to view account balances, transfer funds, and/or perform other actions with respect to their financial accounts).

Even as these functionalities become more widely available to a larger number of people, however, users of mobile devices continue to demand greater convenience, more functionality, and individualized experiences from both their mobile devices and the organizations that provide the applications and other computer software that enables these and other features.

### SUMMARY

Aspects of the disclosure relate to various systems and techniques that provide more convenient, easy-to-use, and functional ways of providing enhanced customer experiences, particularly to a user of a mobile device in a retail location.

For example, some embodiments discussed in greater detail below provide techniques for detecting the presence of a customer based on his or her mobile device (e.g., during a visit to a retail location owned and/or operated by an organization), and subsequently identifying the customer based on the detection of the mobile device. By passively determining the identity of the customer based on the detected presence of his or her mobile device, more individualized, responsive, and convenient service can be provided to the customer (e.g., during his or her visit to the retail location), as having knowledge about the customer's identity may enable the organization (as well as one or more servers and/or other devices operated by the organization at the retail location) to better understand, predict, determine, and/or serve the customer's needs.

For instance, in the example above, the customer is likely visiting the retail location to accomplish one or more specific goals. In many instances, these goals are unknown to the organization operating the retail location and the employees of the organization who may be present at the retail location. By implementing various aspects of the disclosure, however, the customer's goals (which may also be referred to as the customer's “needs”) may be better understood, predicted, and/or determined so as to enable the customer to have his or her needs be better served by the organization. For example, some embodiments provide for selectively notifying certain employees at the retail location about the customer's presence, identity, and/or needs, so as to enable the customer to receive more personalized service. Other embodiments provide for directly servicing the customer at a greeter location (e.g., by a greeter employee) using a mobile computing device, such as a tablet computer, which may have detected and/or otherwise recognized the presence of the customer in the first place. For instance, such detection and/or recognition may be performed by the mobile computing device (e.g., the tablet computer) itself and/or by one or more sniffer systems and/or other detection systems operating alone or in combination with the mobile computing device.

Still other embodiments provide for enabling enhanced functionalities on the customer's own mobile device while the customer and their mobile device are present at the retail location. For example, geo-fencing capabilities may be deployed and/or utilized to provide additional functionalities within one or more apps on the customer's mobile device while the device is present at the retail location, and these additional functionalities may enable the customer perform a variety of different tasks. For instance, if the customer is visiting the retail location (which may, e.g., be a banking center) to open an account, apply for a loan, or complete some other task, the additional functionalities that are geo-enabled on the customer's mobile device may allow the customer to start filling out one or more forms (and/or may allow the customer to provide other information to the organization) that might be needed and/or otherwise involved in completing these tasks. These features, as well as others provided by various other aspects of the disclosure, can not only enable a customer to receive better customer service during a visit to a retail location, but can also increase the customer's satisfaction with respect to their visit to the retail location, for instance, by allowing the customer to be more productive with their time and/or otherwise reducing the customer's perception that they are waiting.

Moreover, although some functionalities discussed herein are described as being provided in a retail location, it should be understood that, in some embodiments, similar functionalities may be provided in other types of locations and/or environments. In addition, a “retail location” may broadly encompass any location, place, or other space that is owned, operated, and/or controlled by organization and in which a customer of a such an organization is served (e.g., regardless of whether the customer purchases goods or services at the location or merely received customer service from the organization at the location).

Thus, in some embodiments discussed below, a computing device may receive information about a mobile device detected within a predetermined distance of a retail location. Subsequently, the computing device may determine, based on the received information, an identity of a customer using the mobile device. Then, the computing device may determine one or more needs of the customer based on the identity of the customer. Thereafter, the computing device may generate routing information for the customer based on the identity of the customer and the one or more determined needs of the customer.

In one or more arrangements, determining the one or more needs of the customer may include predicting at least one need of the customer based on at least one of customer product information, customer presence information, customer history information, customer account information, and customer profile information.

In some arrangements, the computing device also may notify one or more retail associates at the retail location about the customer. In some instances, notifying the one or more retail associates includes selectively notifying at least one retail associate based on the one or more determined needs of the customer.

In other arrangements, generating the routing information for the customer may include determining that the one or more determined needs of the customer can be handled at the computing device.

In still other arrangements, the computing device also may cause the generated routing information to be provided to the mobile device. In some instances, causing the generated routing information to be provided may include causing one or more user interfaces to be displayed on the mobile device, where the one or more user interfaces are configured to receive information from the customer associated with the one or more determined needs.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented;

FIG. 1B illustrates another example operating environment in which various aspects of the disclosure may be implemented;

FIG. 2 illustrates an example system for providing enhanced customer experiences according to one or more embodiments;

FIG. 3 illustrates a flowchart that depicts an example method of providing enhanced customer experiences according to one or more embodiments;

FIG. 4 illustrates an example user interface that may be displayed when a mobile device is detected and a customer is identified according to one or more embodiments;

FIG. 5 illustrates an example user interface that may be displayed when one or more customer needs are determined and routing information is generated according to one or more embodiments;

FIG. 6 illustrates an example user interface that may be displayed to notify one or more associates about the presence of a customer according to one or more embodiments; and

FIG. 7 illustrates an example user interface via which customer information may be received according to one or more embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

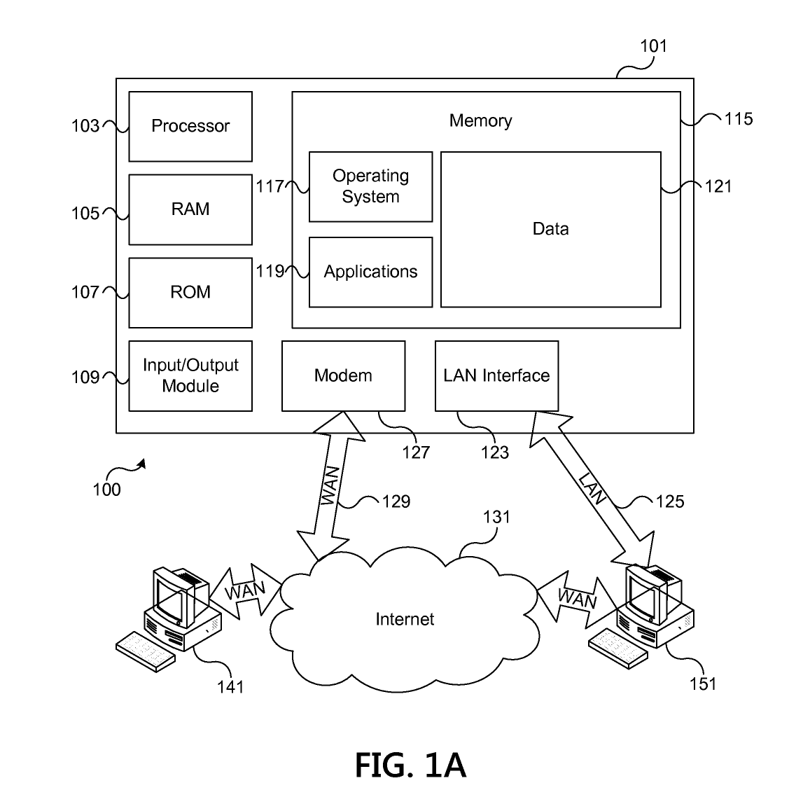

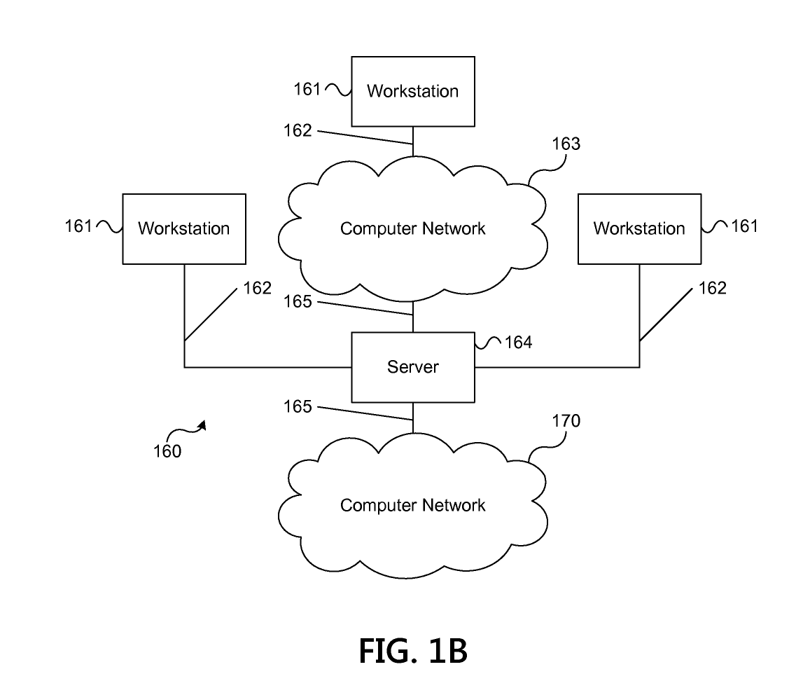

As noted above, certain embodiments are discussed herein that relate to providing enhanced customer experiences. Before discussing these concepts in greater detail, however, an example of a computing device that can be used in implementing various aspects of the disclosure, as well as an example of an operating environment in which various embodiments can be implemented, will first be described with respect to FIGS. 1A and 1B.

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, and so on) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail.

As introduced above, some aspects of the disclosure generally relate to providing enhanced customer experiences. For instance, customers of businesses, including customers of large organizations such as financial institutions, are increasingly demanding more personalized customer service, and these organizations may wish to develop and implement increasingly sophisticated systems and methods to allow associates, employees, and/or other individuals to provide customers with higher levels of customer service. In the discussion below, various examples illustrating how a number of different customer experiences can be provided in accordance with one or more embodiments will be discussed.

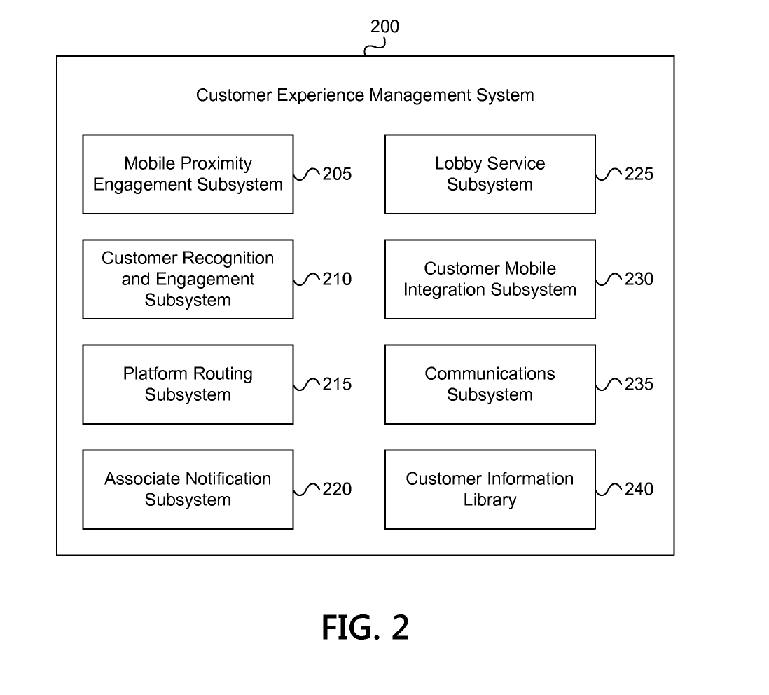

FIG. 2 illustrates an example system for providing enhanced customer experiences according to one or more embodiments. As seen in FIG. 2, system 200 may include one or more subsystems and/or other elements that each may be configured to provide different functionalities. In some embodiments, system 200 and the various subsystems and/or other elements included therein may be implemented in a single computing device. In other embodiments, system 200 may be implemented in one or more different and/or discrete computing devices which may, for example, be networked and/or otherwise connected to enable the various subsystems and/or other elements to exchange data with each other.

In some embodiments, system 200 may include a mobile proximity engagement subsystem 205. Mobile proximity engagement subsystem 205 may, for example, include and/or be configured to function as a device sniffer system that detects and/or identifies other computing devices, including mobile computing devices (which may, e.g., be used by a customer in accordance with various aspects of the disclosure). Such a sniffer system may, for example, detect and/or identify other computing devices based on receiving and/or processing signals that are actively and/or passively transmitted by these other computing devices. In some instances, mobile proximity engagement subsystem 205 may recognize another computing device based on a serial number and/or another unique identifier that is assigned to and/or otherwise associated with the other computing device. In other instances, mobile proximity engagement subsystem 205 may recognize another computing device based on a user account that is currently logged into the device and/or an app running on the device (e.g., a mobile banking app). In some arrangements, mobile proximity engagement subsystem 205 may use additional and/or alternative techniques to detect mobile devices and/or customer devices in addition to and/or instead of those discussed here.

In some embodiments, system 200 may include a customer recognition and engagement subsystem 210. Customer recognition and engagement subsystem 210 may, for example, be configured to store and/or access information about various customers and/or information about various devices that may be linked to particular customer accounts. Such information may, for instance, correlate computing devices identified by mobile proximity engagement subsystem 205 with customer names, account information, and/or other customer information. Additionally or alternatively, customer recognition and engagement subsystem 210 may be configured to create and/or dynamically update a list of customers present at a particular location where system 200 is deployed (which may, e.g., be a retail location, such as a banking center). In some arrangements, customer recognition and engagement subsystem 210 may be in constant and/or periodic communication with mobile proximity engagement subsystem 205, which may enable customer recognition and engagement subsystem 210 to dynamically update such a list of customers present at the location. In instances in which system 200 is implemented in a tablet computer or other mobile computing device, customer recognition and engagement subsystem 210 may enable an employee at a retail location (e.g., a banking center) to view a list of customers present at the location and/or access additional information about the customers. For example, each name in such a list (which may be generated and/or caused to be displayed by customer recognition and engagement subsystem 210) may be user-selectable, and in response to receiving a selection of a particular customer name, customer recognition and engagement subsystem 210 may cause system 200 and/or one or more other computing devices (e.g., a tablet computer used by the employee at the retail location, a mobile device used by the customer, and/or one or more other devices) to display additional information about the customer, such as customer account information, customer history information, customer profile information, information about products that the customer might be interested in, customer presence information, and/or other types of information. In some arrangements, customer recognition and engagement subsystem 210 may provide and/or communicate with customer relationship management (CRM) systems and/or software to provide some and/or all of these functionalities.

In some instances, mobile proximity engagement subsystem 205 and customer recognition and engagement subsystem 210 may operate together to enable system 200 to recognize a customer, based on their mobile device, as they walk into and/or otherwise enter a retail location (which may, e.g., be a banking center). Because system 200 can recognize individual customers as they enter a retail location, system 200 can identify, predict, and/or determine (and subsequently respond to) the individual needs and/or preferences of the identified customers based on information that is available about and/or maintained with respect to the particular customers. Such information may, for instance, include information about products and/or services that are currently being and/or previously were purchased and/or used by the customer, demographic information associated with the customer, and/or other types of information, as illustrated in the examples discussed below.

In some embodiments, system 200 may include a platform routing subsystem 215. Platform routing subsystem 215 may, for example, be configured to determine one or more needs of an identified customer (which may be a customer that, e.g., was detected by mobile proximity engagement subsystem 205 and subsequently identified by customer recognition and engagement subsystem 210). In addition, platform routing subsystem 215 may be further configured to generate routing information for the customer based, for instance, on the customer's identity and the one or more determined needs of the customer.

In determining and/or predicting customer needs, platform routing subsystem 215 may, for example, retrieve, access, and/or load customer information, and subsequently analyze the information, to identify and/or select particular offers that may be provided to the customer and may be well-received by the customer. In addition to identifying and/or selecting offers for the customer, platform routing subsystem 215 also may identify potential sales opportunities with respect to the customer during the customer's current visit to the retail location (which may, e.g., be a banking center) and/or may identify one or more potential and/or probable reasons as to why the customer is currently visiting the retail location, such as a desire to purchase a particular product or service. As discussed in greater detail below, some of the information that may be analyzed (e.g., by platform routing subsystem 215 and/or system 200) to determine and/or predict customer needs may include customer product information, customer presence information, customer history information, customer account information, and/or customer profile information.

After one or more customer needs have been determined and/or predicted, platform routing subsystem 215 may generate routing information that may, for example, be provided to and/or used by one or more employees, associates, and/or other individuals at the retail location, so as to enable these individuals to approach, engage with, and/or serve the identified customer. In some embodiments, the routing information generated by platform routing subsystem 215 may be configured to cause these individuals to approach, engage with, and/or serve the identified customer in one or more particular ways. For example, the routing information may specify and/or otherwise include one or more particular people, teams, departments, and/or groups at the retail location (which may, e.g., be a banking center) with whom the customer should meet; one or more particular areas at, near, and/or within the retail location that the customer should visit; and/or other information that may cause an individual at the retail location to engage with and/or serve the customer in one or more particular ways.

In some embodiments, in generating and/or providing routing information, platform routing subsystem 215 may cause system 200 to display a user interface that may include information about the customer. Such information may, for instance, be configured to cause and/or assist an individual at the retail location to engage with and/or serve the particular customer. Additionally, the user interface may, for example, include the customer's name, picture, and/or other information about the customer. In an example in which system 200 and/or platform routing subsystem 215 are used by a financial institution at a banking center, a user interface that may be generated by platform routing subsystem 215 may include information about potential selling opportunities that are specific to the identified customer, account summaries for the identified customer, history of previous visits to various banking centers (e.g., dates, times, locations, and so on), predicted needs of the customer (e.g., reporting unauthorized usage of a payment card, following up on a mortgage application, opening a new account, and so on).

In some embodiments, system 200 may further include an associate notification subsystem 220. Associate notification subsystem 220 may, for example, be configured to notify and/or inform one or more employees, associates, and/or other individuals at a retail location (which may, e.g., be a banking center) about a customer that has been identified (e.g., by mobile proximity engagement subsystem 205 and/or customer recognition and engagement subsystem 210). Additionally or alternatively, associate notification subsystem 220 may be configured to notify and/or inform one or more employees, associates, and/or other individuals at the retail location about the determined and/or predicted needs of the customer, as well as the routing information that may have been generated, as determined, for instance, by platform routing subsystem 215.

For example, after a customer has been detected, recognized, and/or identified, system 200 may display (or may cause to be displayed, e.g., on a display screen included in the same device as system 200 and/or in another device communicatively coupled to system 200) a user interface and/or a user interface element that is configured to notify an employee, associate, and/or other individual (who may, e.g., be using the device) of the customer's presence, the customer's needs, and/or the generated routing information. Such a notification may be proactive in that it may prompt and/or otherwise cause information to be displayed and/or otherwise presented on one or more devices being used by employees, associates, and/or other individuals at the retail location, without a request being received from (or other input being provided by) these individuals.

In some instances, the one or more notifications that are generated, sent, and/or caused to be displayed by associate notification subsystem 220 may be selectively generated, sent, and/or caused to be displayed to certain employees, associates, and/or other individuals based on one or more factors. For example, notifications may be selectively generated, sent, and/or caused to be displayed (e.g., by associate notification subsystem 220) for certain employees, associates, and/or other individuals at a retail location based on availability, such that individuals who are with a customer and/or otherwise busy might not receive a particular notification, whereas other individuals who are available and/or otherwise free to assist the identified customer may receive the notification (which may, e.g., notify the individual of the customer's presence, identity, needs, and so on, as discussed above). Additionally or alternatively, notifications may be selectively generated, sent, and/or caused to be displayed for certain employees, associates, and/or other individuals at the retail location based on the identified customers needs (which may, e.g., be determined and/or predicted by platform routing subsystem 215, as discussed above) and/or based on the skills, abilities, and/or expertise of each individual at the retail location (which may, e.g., indicate whether a particular employee or associate can assist and/or serve the identified customer with respect to their determined and/or predicted needs).

For example, associate notification subsystem 220 may, in some instances, cause an employee, associate, or other individual who can handle the customer's needs at the retail location to receive a notification, while one or more other employees, associates, and/or other individuals who cannot handle the customer's needs might not receive the notification. For instance, if a customer is detected (e.g., by mobile proximity engagement subsystem 205) upon entering a retail location, such as a banking center operated by a financial institution, and the customer identified (e.g., by customer recognition and engagement subsystem 210) as someone who is working on a loan application, and it is predicted and/or determined (e.g., by platform routing subsystem 215) that the customer is visiting the banking center for assistance with the loan application, one or more selective notifications may be sent (e.g., by associate notification subsystem 220) to one or more loan officers who are present and available at the banking center, rather than notifying all of the employees who are present at the banking center. In other words, system 200 may, in some embodiments, be configured to generate role-specific notifications (e.g., for employees, associates, and/or other individuals) based on customer detection and identification, as well as on determined and/or predicted customer needs and employee/associate skills and availability.

In some embodiments, system 200 may further include a lobby service subsystem 225. Lobby service subsystem 225 may, for example, enable an employee, associate, and/or other individual at the retail location (which may, e.g., be a banking center) to complete certain tasks for the customer immediately at the time when the customer is greeted. For instance, lobby service subsystem 225 may enable such an individual to complete quick and/or simple tasks for the customer, such as resetting an account password or updating an account address or phone number, to reduce the amount of time that the customer has to wait and/or to prevent the customer from having to stand in line. In some instances, lobby service subsystem 225 thus may be configured to provide certain functionalities that may be used by a greeter or other specialized employee, associate, or other individual at the retail location. Additionally or alternatively, lobby service subsystem 225 may enable system 200 to provide a full range of functionalities, similar to other full-featured computing devices used by employees, associates, and/or other individuals at the retail location, so as to provide flexibility in enabling a user of system 200 to provide service to customers at the retail location on an on-demand basis.

In some embodiments, system 200 may further include a customer mobile integration subsystem 230. Customer mobile integration subsystem 230 may, for example, be configured to communicate with one or more customers' mobile devices (e.g., after such devices are detected by mobile proximity engagement subsystem 205) and/or further configured to enable additional functionalities on such mobile devices during the time(s) in which the devices are present at the retail location. For example, in instances where system 200 is used by a financial institution and/or deployed at a banking center, system 200 and/or customer mobile integration subsystem 230 may enable additional functionalities to be provided to a customer within a mobile banking software application (that may, e.g., be executed on the customer's mobile device). In addition, such additional functionalities may be provided to the customer based on the mobile device's detected presence at the banking center. In some instances, enabling and/or providing these additional functionalities may include providing targeted marking and/or advertising content on the mobile device (e.g., offers, advertisements, and the like) related to products and/or services that are available at the banking center. In other instances, enabling and/or providing such additional functionalities may include providing one or more user interfaces that enable a customer to fill out forms (e.g., to provide information that might be needed by a financial institution in connection with the tasks that the customer is completing at a banking center, such as applying for a loan or mortgage).

For example, if the customer is visiting a banking center where system 200 is deployed, and the customer is visiting the banking center in order to open a new account or apply for a loan, customer mobile integration subsystem 230 may enable the customer to fill out one or more forms and/or provide other information to accomplish one or more of these tasks via the mobile banking application on the customer's personal mobile device. For instance, while the customer is waiting in the banking center to meet with one or more specialized employees, associates, and/or other individuals, such as an account manager or loan officer, the customer can interact with user interfaces provided on their own mobile device, and these user interfaces may be provided (or caused to be provided) by customer mobile integration subsystem 230. In these ways, customer mobile integration subsystem 230 may function to reduce the customer's perception that they are simply waiting around or wasting time by instead engaging the customer in a way that uses their time more productively, while also increasing the efficiency of the interactions between the customer and the one or more employees, associates, and/or other individuals at the banking center.

In some embodiments, system 200 also may include a communications subsystem 235. Communication subsystem 235 may, for example, include one or more wired communications interfaces (e.g., Ethernet) and/or wireless communication interfaces (e.g., cellular, wireless local area networking (WLAN), Bluetooth, and/or the like). The communication interface(s) included in communication subsystem 235 may, for instance, enable system 200 and/or the one or more subsystems included in system 200 to send information to, and receive information from, one or more other computing devices and/or networks.

In some embodiments, system 200 may further include a customer information library 240. Customer information library 240 may, for example, store information about various customers and/or information about the various devices that may be used by various customers. This information may, for instance, be used by the other subsystems included in system 200 in providing one or more of the functionalities discussed above. In some instances, information in customer information library 240 also may be synchronized with one or more central databases that may, for example, be maintained on one or more remote servers and/or other remote systems.

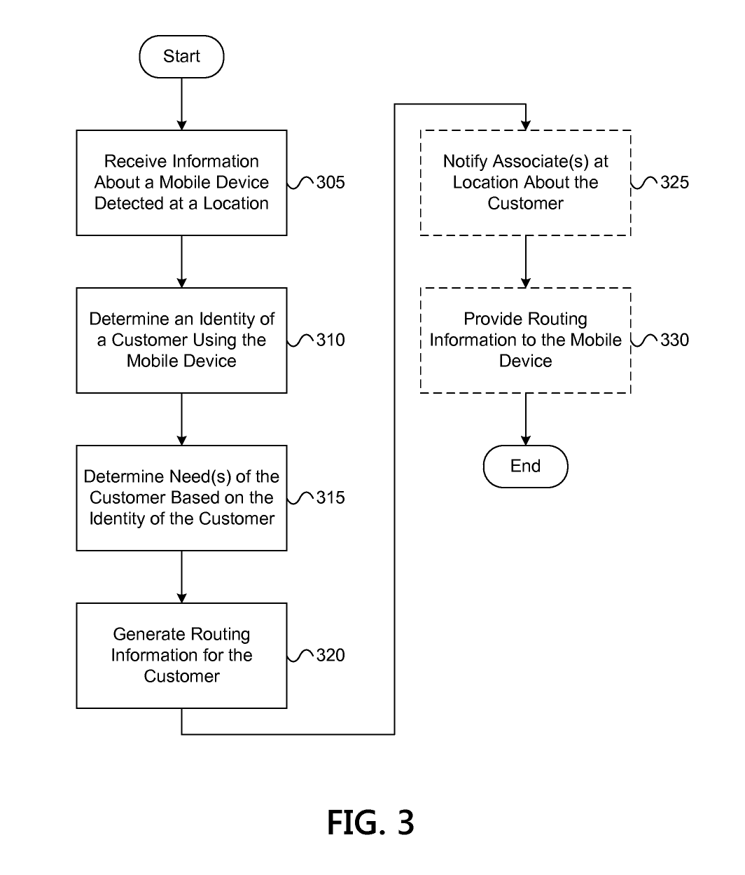

FIG. 3 illustrates a flowchart that depicts an example method of providing enhanced customer experiences according to one or more embodiments. In some embodiments, the method illustrated in FIG. 3 and/or one or more steps thereof may be performed by a computing device, such as computing device 101 or system 200. Additionally or alternatively, the method illustrated in FIG. 3 and/or one or more steps thereof may be embodied in computer-executable instructions that are stored in and/or configured to be stored in a computer-readable medium, such as a memory.

As seen in FIG. 3, the method may begin in step 305, in which information about a mobile device that has been detected at a location may be received. For example, in step 305, a computing device executing the method illustrated in FIG. 3 may receive information indicating that a mobile device has been detected at a particular location and/or within a predetermined distance of the particular location (which may, e.g., be a retail location, such as a banking center). In some instances, the information received in step 305 may be received from a detection system that includes one or more sniffer components. In other instances, such information may be received from another component or subsystem included in the computing device that is executing the method and/or performing step 305.

In some embodiments, the information received in step 305 may include one or more identifiers that are assigned to and/or otherwise associated with the mobile device, such as a device serial number, an international mobile station equipment identity (IMEI) value, a subscriber identity module (SIM) value, a software serial number, one or more product codes, and/or the like. Additionally or alternatively, the information received in step 305 may include the distance between the mobile device and the retail location, if it is determined, for instance, that the mobile device is not located at a particular point within the retail location.

In step 310, an identity of a customer using the mobile device may be determined. For example, in step 310, the computing device executing the method illustrated in FIG. 3 may retrieve, load, and/or access device correlation information (which may, e.g., be stored by the computing device itself, such as in customer information library 240, or by one or more other computing devices, such as one or more remote servers). The device correlation information may, for instance, associate particular device identifiers and/or other characteristics with particular customers and/or user accounts (which may, e.g., be used by particular customers). Subsequently, the computing device may compare the information received in step 305 (which may, e.g., include one or more identifiers that are assigned to and/or otherwise associated with the detected mobile device) with the device correlation information in order to determine the identity of the customer and/or user account that is associated with the detected mobile device.

In some instances, a particular mobile device may be associated with two or more user accounts and/or customers. In these instances, the customer identity determined in step 310 may be determined based on which user account is currently logged in (e.g., currently logged into the operating system, a particular software application, such as a mobile banking application, and/or the like). Additionally or alternatively, in these instances, the customer identity determined in step 310 may be determined based on user input received in response to a prompt displayed on the mobile device, where the prompt asks the user to authenticate and/or otherwise provide identifying information to identify themselves.

In step 315, one or more needs of the customer may be determined based, at least in part, on the identity of the customer. For example, in step 315, the computing device executing the method illustrated in FIG. 3 may determine one or more needs of the customer based on the customer identity determined in step 310. In some instances, customer needs may be determined by prompting the customer (e.g., on their mobile device) and/or causing the customer to be prompted (e.g., on their mobile device and/or on the employee or associate's device) to enter, identify, and/or specify their needs and/or reasons for visiting the retail location (which may, e.g., be a banking center). In other instances, customer needs may be determined by prompting the employee or associate (and/or otherwise causing the employee or associate to be prompted) to ask the customer about their needs and/or reasons for visiting the retail location, and subsequently receiving information from the employee or associate that includes the customer's response(s).

In some embodiments, determining the one or more needs of the customer may include predicting at least one need of the customer. In some instances, customer needs may be predicted based on customer product information, customer presence information, customer history information, customer account information, and/or customer profile information. Customer product information may, for example, include information about products that the customer has previously purchased and/or products that the customer has expressed interest in. For instance, if the customer of a financial institution has started a mortgage application online or during a previous visit to a retail location (e.g., a banking center), it may be determined that the customer has expressed interest in mortgage products when determining and/or predicting needs of the customer. Customer presence information may, for example, include information about which store and/or retail location the customer is currently visiting (e.g., information identifying the physical and/or geographic location of the store, information indicating the relative location of the store in relation to one or more other stores and/or customer locations, such as the customer's home) and/or other information about the customer's current visit (e.g., what time the customer arrived, how long the customer has been present at the location, and/or the like). Customer history information may, for example, include information about a customer's previous visits to one or more retail locations (e.g., the time(s) and/or date(s) of such visits, the geographic location(s) that were previously visited by the customer, the product(s) purchased during and/or after such visits, and/or the like). In some instances, customer history information might not only include information about the customer's previous visits to the store and/or company that is currently being visited by the customer, but also may include information about the customer's previous visits to other stores (which may, e.g., be operated by different companies, organizations, and/or other entities). Customer account information may, for example, include information about the customer's current and/or previous accounts, such as the types of accounts that the customer has, the value of the accounts that the customer has, and/or other information associated with the customer's accounts. Customer profile information may, for example, include the customer's age, gender, and/or other demographic information associated with the customer.

In step 320, routing information may be generated for the customer. For example, in step 320, the computing device that is executing the method illustrated in FIG. 3 may generate routing information for the customer based on the identity of the customer (e.g., as determined in step 310) and/or based on the needs of the customer (e.g., as determined in step 315). In some embodiments, the routing information may, for instance, specify that the customer should visit certain areas of the retail location and/or meet with certain employees, associates, and/or other individuals at the retail location. This may be determined based on the customer's identity and determined needs to ensure that the customer visits the right areas and/or meets with the right people during their visit to the retail location. So if, for example, the customer's determined needs include completing a mortgage application, the routing information generated in step 320 may indicate that the customer should visit a loan service center within the retail location and/or meet with one or more particular loan officers who are present at the retail location.

In some instances, generating the routing information for the customer may include determining that the one or more determined needs of the customer can be handled at the computing device (e.g., at the computing device that is executing the method illustrated in FIG. 3). In these instances, the routing information generated in step 320 may, for example, indicate that the customer should be serviced by a greeter or other person who may greet the customer upon entering the retail location. Such a person may, for example, be operating the computing device that is executing the method illustrated in FIG. 3 (which may, e.g., be a tablet computer into which system 200 is incorporated) and/or may be responsible for delivering the generated routing information to the customer.

In step 325, one or more associates at the retail location may be notified about the customer. For example, the computing device executing the method may generate and/or send one or more notifications to one or more employees, associates, and/or other individuals who may be present at the retail location. Additionally, in some instances, notifying the one or more retail associates may include selectively notifying at least one associate based on the one or more determined needs of the customer. For example, certain associates at the location may be notified, while others are not, as discussed above in connection with associate notification subsystem 220.

In step 330, the routing information may be provided to the mobile device. For example, the computing device executing the method may send, transmit, and/or otherwise provide the routing information to the customer's mobile device (which, e.g., may have been detected in step 305). In some instances, providing the routing information to the mobile device may include sending routing information to the customer's mobile device and/or causing such information to be displayed so as to route the customer to the appropriate person and/or place in the store. In some embodiments, causing the generated routing information to be provided may include causing one or more user interfaces to be displayed on the mobile device, and these user interfaces may be configured to receive information from the customer associated with the one or more determined needs. For example, the one or more user interfaces to be displayed may allow the customer to enter information and/or fill out forms before meeting with a store employee or associate to discuss a certain product or service associated with the information and/or forms.

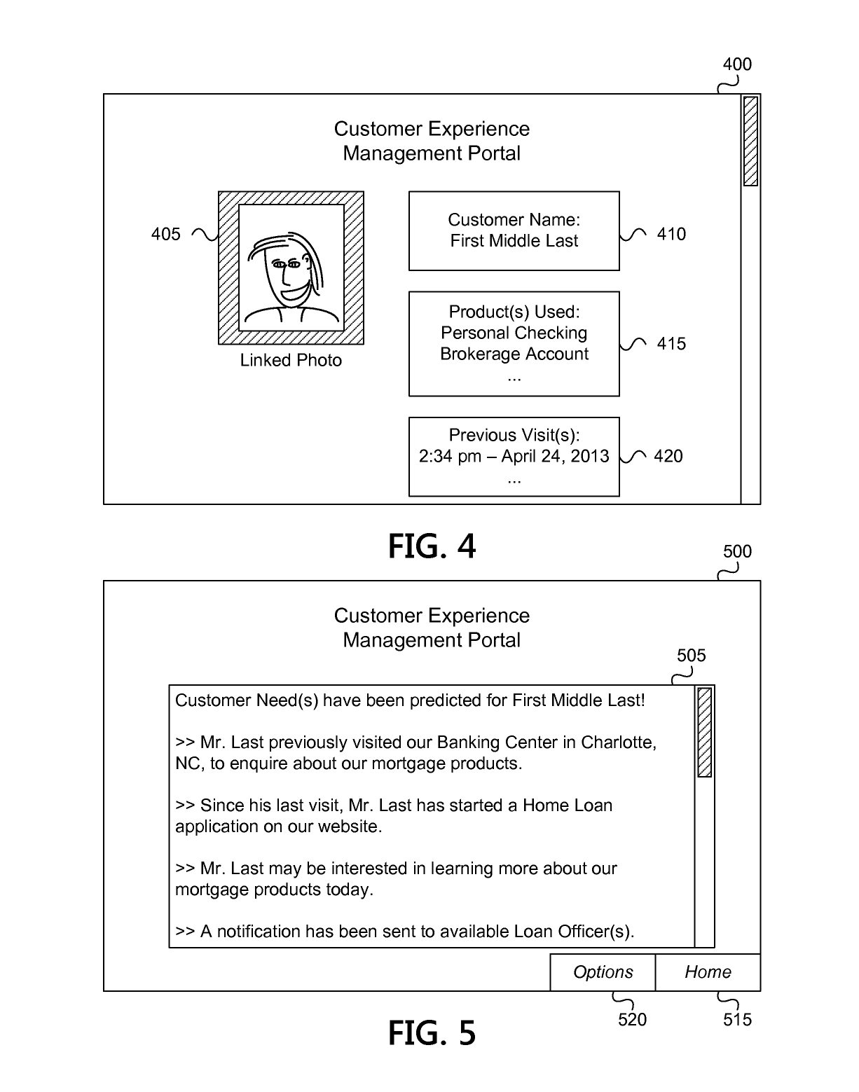

Having discussed several examples of the processing that may be performed in some embodiments, several user interfaces that may be displayed and/or otherwise provided will now be discussed in greater detail with respect to FIGS. 4-7. Any and/or all of the example user interfaces discussed herein may be displayed by a computing device, such as computing device 101 or system 200.

FIG. 4 illustrates an example user interface 400 that may be displayed when a mobile device is detected and a customer is identified according to one or more embodiments. As seen in FIG. 4, user interface 400 may include an image 405 of the customer that has been identified, as well as other information about the customer. For example, user interface 400 may include the customer's name 410, information 415 about the products that are used by the customer, and additional information 420 about the customer's previous visits to the retail location. In other arrangements, additional and/or alternative information may similarly be displayed after a mobile device has been detected and a customer has been identified. Additionally or alternatively, such information and/or user interface 400 may be displayed on a tablet computer used by a greeter at the retail location, who may, for instance, be responsible for welcoming to the customer to the retail location and initially engaging the customer.

FIG. 5 illustrates an example user interface 500 that may be displayed when one or more customer needs are determined and routing information is generated according to one or more embodiments. As seen in FIG. 5, user interface 500 may include a region 505 in which generated routing information may be displayed. The routing information may, for example, include information about the customer's previous visit(s) to the retail location or another retail location, information about the customer's interest in certain products, information about the predicted needs of the customer, and/or other information. As discussed above, this routing information may enable an employee, associate, or other individual (who may be operating the computing device on which user interface 500 is displayed) to engage the customer and serve them with more efficient and personalized customer service. In the illustrated example, for instance, the routing information included in region 505 may prompt the associate to ask the customer about an in-progress mortgage application, and further may reflect the status of a selective notification process that may be executed in accordance with other aspects of the disclosure discussed above. In addition, user interface 500 may include several navigation controls, such as home button 515 and/or options button 520.

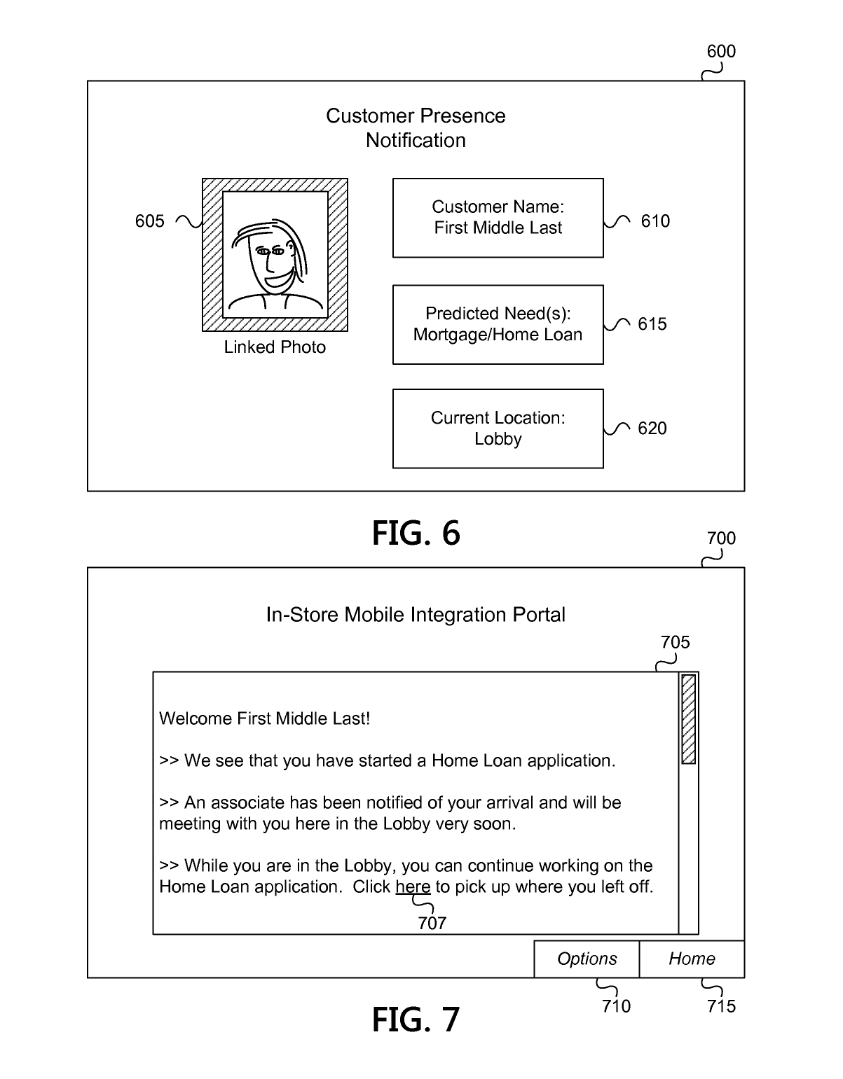

FIG. 6 illustrates an example user interface 600 that may be displayed to notify one or more associates about the presence of a customer according to one or more embodiments. Such a notification may, for instance, be displayed on an employee's, associate's, or other individual's device in accordance with a selective notification process, as discussed above (e.g., with respect to associate notification subsystem 220). As seen in FIG. 6, user interface 600 may include a picture 605 of the customer that has been identified and greeted, as well as other information about the customer. For example, user interface 600 may include the name 610 of customer, information 615 about the predicted needs of the customer (which may, e.g., have been predicted in generating routing information for the customer, in accordance with various aspects discussed above), and/or other information 620 about the customer, such as the current location of the customer within the retail location and/or current status of the customer.

FIG. 7 illustrates an example user interface 700 via which customer information may be received according to one or more embodiments. Such a user interface may, for instance, be displayed on a customer's personal mobile device after the device has been detected at the retail location (e.g., as discussed above with respect to customer mobile integration subsystem 230). As seen in FIG. 7, user interface 700 may include a region 705 that includes routing information (which may, e.g., have been generated in accordance with various aspects discussed above) and/or one or more options, controls, and/or fields that enable the user to provide customer information. For instance, in the example illustrated in FIG. 7, region 705 includes a hyperlink 707 that enables that the customer to access another user interface via which additional information can be entered (e.g., “Click here to pick up where you left off”).

In addition to and/or instead of one or more of the features discussed above with respect to various embodiments and arrangements, some additional features may be provided in some additional and/or alternative embodiments. For example, system 200 may, in some instances, be implemented in a tablet computer, and the tablet computer may feature two-factor authentication technology. Additionally or alternatively, the customer may be able to swipe their credit card, debit card, or other payment card in a reader connected to the tablet computer to unlock additional functionalities, access their accounts, and/or perform other functions. The customer also may be able to enter digital signatures on the tablet computer. Additionally or alternatively, the tablet computer may be used to create, generate, and/or monitor various metrics. Examples of metrics that may be monitored by the tablet computer (and/or by system 200) include customer wait time by routing channel, number of customers successfully identified based on their mobile device, number of customers serviced at the tablet by the greeter, and the like.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

1. A computing device, comprising:
at least one processor; and
memory storing computer readable instructions that, when executed by the at least one processor, cause the computing device to:
receive information associated with a mobile device detected at a banking center, the mobile device being used by a customer of a financial institution operating the banking center;
determine, based on the received information, an identity of the customer using the mobile device;
determine, based on the identity of the customer using the mobile device, one or more needs of the customer associated with the customer's visit to the banking center; and
generate routing information for the customer based on the identity of the customer and the one or more determined needs of the customer, the routing information including information specifying at least one individual at the banking center for the customer to meet with during the customer's visit to the banking center.

2. The computing device of claim 1, wherein determining the one or more needs of the customer includes predicting at least one need of the customer based on at least one of customer product information, customer presence information, customer history information, customer account information, and customer profile information.

3. The computing device of claim 1, wherein the memory stores additional computer readable instructions that, when executed by the at least one processor, further cause the computing device to:
notify one or more retail associates at the banking center about the customer.

4. The computing device of claim 3, wherein notifying the one or more retail associates includes selectively notifying at least one retail associate based on the one or more determined needs of the customer.

5. The computing device of claim 1, wherein generating the routing information for the customer includes determining that at least one need of the one or more determined needs of the customer can be handled at the computing device.

6. The computing device of claim 1, wherein the memory stores additional computer readable instructions that, when executed by the at least one processor, further cause the computing device to:
cause the generated routing information to be provided to the mobile device.

7. The computing device of claim 6, wherein causing the generated routing information to be provided includes causing one or more user interfaces to be displayed on the mobile device, the one or more user interfaces being configured to receive information from the customer associated with the one or more determined needs.

8. A method, comprising:
receiving, by a computing device, information associated with a mobile device detected at a banking center, the mobile device being used by a customer of a financial institution operating the banking center;
determining, by the computing device, based on the received information, an identity of the customer using the mobile device;
determining, by the computing device, based on the identity of the customer using the mobile device, one or more needs of the customer associated with the customer's visit to the banking center; and
generating, by the computing device, routing information for the customer based on the identity of the customer and the one or more determined needs of the customer, the routing information including information specifying at least one individual at the banking center for the customer to meet with during the customer's visit to the banking center.

9. The method of claim 8, wherein determining the one or more needs of the customer includes predicting at least one need of the customer based on at least one of customer product information, customer presence information, customer history information, customer account information, and customer profile information.

10. The method of claim 8, further comprising:
notifying, by the computing device, one or more retail associates at the banking center about the customer.

11. The method of claim 10, wherein notifying the one or more retail associates includes selectively notifying at least one retail associate based on the one or more determined needs of the customer.

12. The method of claim 8, wherein generating the routing information for the customer includes determining that at least one need of the one or more determined needs of the customer can be handled at the computing device.

13. The method of claim 8, further comprising:
causing, by the computing device, the generated routing information to be provided to the mobile device.

14. The method of claim 13, wherein causing the generated routing information to be provided includes causing one or more user interfaces to be displayed on the mobile device, the one or more user interfaces being configured to receive information from the customer associated with the one or more determined needs.

15. One or more non-transitory computer-readable media having computer-executable instructions stored thereon that, when executed by a computing device, cause the computing device to:
receive information associated with a mobile device detected at a banking center, the mobile device being used by a customer of a financial institution operating the banking center;
determine, based on the received information, an identity of the customer using the mobile device;
determine, based on the identity of the customer using the mobile device, one or more needs of the customer associated with the customer's visit to the banking center; and
generate routing information for the customer based on the identity of the customer and the one or more determined needs of the customer, the routing information including information specifying at least one individual at the banking center for the customer to meet with during the customer's visit to the banking center.

16. The one or more non-transitory computer-readable media of claim 15, wherein determining the one or more needs of the customer includes predicting at least one need of the customer based on at least one of customer product information, customer presence information, customer history information, customer account information, and customer profile information.

17. The one or more non-transitory computer-readable media of claim 15, having additional computer-executable instructions stored thereon that, when executed by the computing device, further cause the computing device to:
notify one or more retail associates at the banking center about the customer.

18. The one or more non-transitory computer-readable media of claim 17, wherein notifying the one or more retail associates includes selectively notifying at least one retail associate based on the one or more determined needs of the customer.

19. The one or more non-transitory computer-readable media of claim 15, wherein generating the routing information for the customer includes determining that at least one need of the one or more determined needs of the customer can be handled at the computing device.

20. The one or more non-transitory computer-readable media of claim 15, having additional computer-executable instructions stored thereon that, when executed by the computing device, further cause the computing device to:
cause the generated routing information to be provided to the mobile device.

21. The one or more non-transitory computer-readable media of claim 20, wherein causing the generated routing information to be provided includes causing one or more user interfaces to be displayed on the mobile device, the one or more user interfaces being configured to receive information from the customer associated with the one or more determined needs.

22. The method of claim 8, wherein the computing device is configured to recognize the mobile device at the banking center based on a user account associated with a mobile banking application on the mobile device.

23. The method of claim 22, wherein the computing device is configured to enable additional functionality of the mobile banking application based on the mobile device's detected presence at the banking center.

24. The method of claim 8, wherein the computing device is configured to be used by a greeter employee of the financial institution at a greeter location of the banking center.

25. The method of claim 11, wherein selectively notifying the at least one retail associate includes generating at least one role-specific notification for an individual at the banking center based on employee skills and availability.

26. The method of claim 8,
wherein determining the one or more needs of the customer includes determining that the customer is working on a loan application, and
wherein the routing information includes information specifying at least one loan officer at the banking center for the customer to meet with during the customer's visit to the banking center.
